(19) United States
(12) Patent Application Publication
(10) Pub. No.: US 2006/0004638 A1
(43) Pub. Date: Jan. 5, 2006

(54) Assisted electronic product design

(76) Inventors: Eliza H. Royal, Lincoln, MA (US); Vyacheslav Nykyforov, Waltham, MA (US); Jeffrey R. Suarez, Cambridge, MA (US)

Correspondence Address: VISTA PRINT USA INC., 100 HAYDEN AVENUE, LEXINGTON, MA, 02421, US

(21) Appl. No.: 10/884,786

(22) Filed: Jul. 2, 2004

(51) Int. Cl. G06F 17/60

(52) U.S. Cl. 705/26

(57) ABSTRACT

Electronic document design systems and methods for creating customized electronic product designs. A design representative creates customized product designs for a remote customer by combining text and images supplied by the customer over a global communication network with electronically stored layouts, images, color schemes, and other selected component elements. Tools are available to the customer to facilitate supplying information for incorporation into the designs and feedback comments. Images of product designs are made available for viewing by the customer. Automated tools allow the design representative to select and replace component elements and save the resulting product design for review by the customer.

### FIELD OF THE INVENTION

The present invention relates to computer-implemented electronic product design.

### BACKGROUND OF THE INVENTION

From time to time, many individuals, businesses, and organizations have a need for high quality, custom printed materials. These materials could include, for example, a brochure describing a product or service, a promotional postcard notification about an upcoming sale, a birth announcement, a party invitation, or any number of other items.

Typically, only larger enterprises with regular and substantial requirements for designing custom materials are able to justify hiring a graphic designer as an employee. Many individuals and businesses rely on outside professional assistance, such as a local print shop or a professional graphic designer, when the need arises to design and create attractive and high quality materials. This often requires multiple visits or interviews for purposes such as describing requirements, examining representative samples, reviewing proofs, making corrections, picking up the final printed products, and so forth. For busy individuals, trying to schedule these activities may be a significant inconvenience.

As in many other fields, the increasing availability and power of computer hardware and software products have resulting in many advances in efficiency in the graphic design field. In the day-to-day business environment of a graphic designer, software tools have become available to facilitate activities such as receiving customer submissions, tracking and storing of work in progress, and providing of electronic proofs for remote customer review. The wide availability of the internet and email services allow messages and image content to be quickly and inexpensively transferred electronically. Despite these and other technological advances, the actual process of creating the custom design for the customer has changed relatively little. Each job is typically created individually to the particular detailed specifications of the customer. The graphic designer's design processes are typically not designed to be scalable, repeatable, or to adhere to a predefined set of process steps. The result is that the designing of custom printed products generally still involves a significant investment of time by a trained graphic design professional and, therefore, tends to be expensive.

As an alternative to using a graphic designer, various specialized software products are available that present a customer with a set of pre-designed document templates into which the user can insert the user's personal information to allow the user to prepare personalized greeting cards, invitations or the like. These software products must typically be purchased by the user and installed permanently on the user's computer. At least some familiarization and training is required for the product to be used properly and efficiently in a manner that yields satisfactory results. Even if the customer can become trained well enough to use the software, the printing devices connected to the typical personal computer used by an individual or small business are often not suitable for, or not capable of, producing quantities of quality full color materials.

As an alternative to the above approaches, internet printing service providers, taking advantage of the capabilities of the World Wide Web and modern Web browsers, provide document design services for user's desiring to create customized documents from any computer with Web access at whatever time and place is convenient to the user. These service providers typically provide their customers with the ability to access the service provider's web site, view product templates, and create a customized markup language document description either with tools executing on the service provider's server system or using downloaded editing tools executing in the browser of the customer's computer. After the document has been designed by the user, Web-based service providers also typically allow the user to place an order for the production and delivery to the user's home or business of quantities of high quality, printed documents of the type and quality that the user is not capable of producing with the printer systems typically connected to most personal computer systems. The customer is not required to purchase and install any specialized hardware or software and, because the user is performing many of the design related actions using automated tools, the user does not incur fees for the services of a graphic designer. The printed products can be offered to the user at significantly lower prices than would be possible if a graphic designer had been used to prepare the product.

While many users have eagerly adopted the powerful and flexible tools that are provided by online printing service providers to create custom documents, it is common for a large portion of the visitors to a printing services Web site to leave the site either without attempting to design a product or without completing a product that is partially designed. Some potential customers may leave because they have a lack of confidence in their personal ability to use the automated design tools, others may encounter a technical problem or question that they cannot resolve using automated online help or instructions, and yet others may simply not have any interest in personally devoting any effort toward creating a design. These individuals are failing to benefit from the capabilities of these services. Many of these individuals could have been assisted and converted into customers if they had been offered the option of receiving assistance from a human representative with their design project. Web service providers, however, typically operate as “self service” processes with little or no product design support or consultation being available from a human representative of the service provider.

There is, therefore, a clear need for a new system for the design of custom printed products. In particular, a novel system that advantageously employs the abilities of modem personal computers, network systems, and automated design tools to streamline and accelerate the design process while also providing for customer interaction and information sharing with support and design personnel.

### SUMMARY

The present invention is directed to satisfying the need for systems and methods that provide automated cost-effective customized product design with personal service.

An aspect of the invention provides a set of tools for exchanging design project information over a communication network using a customer input tool allowing the customer to submit various content information for the design, a customer review request tool allowing the customer to review prepared designs, and a customer feedback tool allowing the customer to enter comments about the prepared designs.

Another aspect of the invention provides a system for allowing an operator of the system to create custom designs by combining customer supplied content information with stored design components using tools that allow the operator to select design components in a number of categories, create images of the combination of the selected elements and the customer information and save the images for review by the customer.

Another aspect of the invention provides an information submission system for the customer to provide information for use in the design including a text entry form allowing the customer to supply text for use in the design, an image upload tool allowing the customer to transmit one or more images for incorporation into the design, and an image search and selection tool allowing the customer to review and select images available at the server for incorporation into the design.

Further aspects of the invention provide methods creating custom designs by receiving customer information, combining received information with selected components to create custom designs, and saving the designs for customer review.

Further objects, features and other aspects of the invention will be understood from the following description with reference to the attached figures.

### BRIEF DESCRIPTION OF THE DRAWINGS

FIG. 1 is a block diagram of a networked system implemented consistent with the principles of the invention.

FIG. 2 is a depiction of project information display available to the customer.

FIG. 3 is a depiction the customer project information displays available to service representatives.

FIGS. 4A-4D are a flow diagram of a product design method according to the principles of the invention.

FIG. 5 is representation of a custom product design tool according to the principles of the invention.

### DESCRIPTION

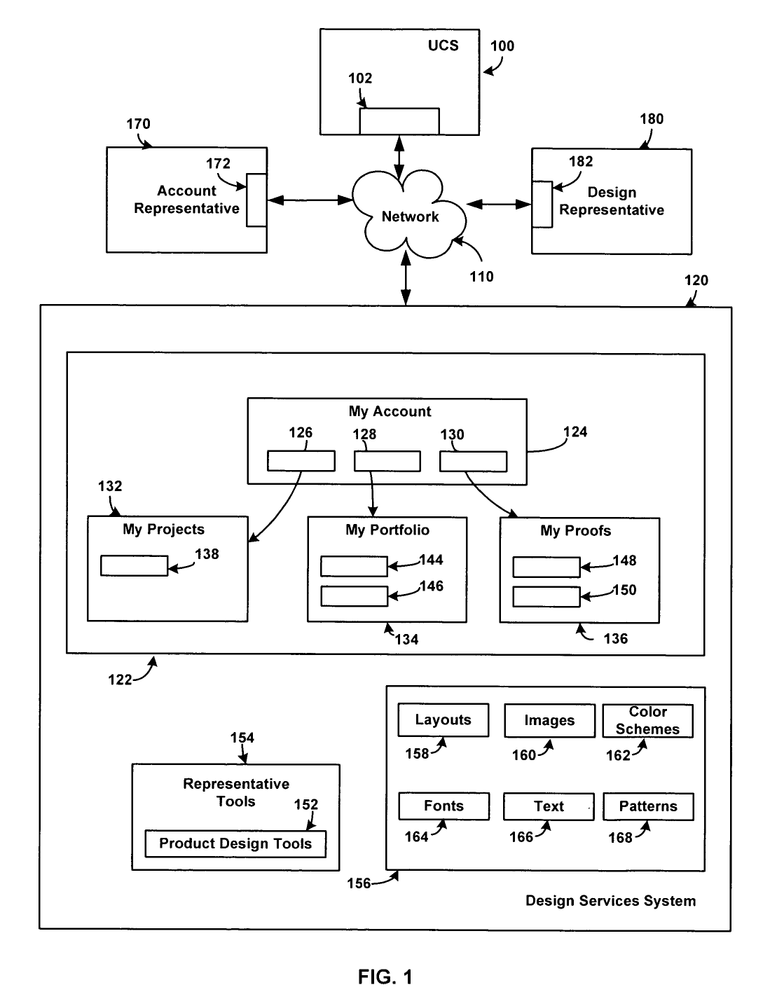

Referring to FIG. 1, user computer system UCS 100 is an intelligent device intended to be operated by a human user. UCS could be a typically equipped modern person computer, but could also be a portable computer, tablet computer, or other device having appropriate technical capabilities. UCS 100 has internal systems and components (not shown) including a processor, memory and data storage systems, a user display, one or more systems for receiving the user's inputs, such as a mouse and keyboard, and a system for supporting connection to and communication with a remote computer system over a network In FIG. 1, UCS 100 is running Web browser 102, such as Internet Explorer from Microsoft Corporation, and communicates with a design service provider's remote server system 120 via global communication network 110.

Design Services System (DSS) 120 represents a Web server system operated by the service provider for performing product design services for a remote user of a UCS 100. DSS 120 could be implemented as a separate product design system or could be implemented as a feature or component of a printing services Web site that also provides other services and products. While DSS 120 is shown in FIG. 1 as a single block, it will be understood that DSS 120 could be comprised of multiple servers and data storage systems configured to communicate and operate cooperatively.

Account representative system 170 and design representative system 180 are typically equipped modern personal computers and associated input/output devices. Systems 170 and 180 are operated by employees or agents of the design service provider, and are identified herein as account representatives and design representatives, respectfully. The systems are in communication with DSS 120 over global network 110. For simplicity and clarity of description and presentation, FIG. 1 depicts a single UCS 100, a single system 170, and a single system 180, but the embodiments of the invention are in no way so limited and there could be multiple systems 170, 180 and UCS 100 connected to DSS 120. While systems 170 and 180 are shown as connected to DSS 120 via global network 110, this type of connection is not required. Either system 170 or 180 or both could communicate with DSS 120 via a direct connection or via a local communication network.

While the account representatives and the design representatives will generally have specific and defined functions and responsibilities, it is possible that there may be some overlap in their duties. Also, from time to time, exceptionally heavy or light customer call volume, exceptionally heavy or light design workloads, or other circumstances could arise. The disclosed embodiment is, therefore, a flexible system that allows the service provider to respond to changing circumstances by allowing both account and design representatives to have access to the same tools and displays. Systems 170 and 180 are, therefore, differentiated by the functions currently being performed by the operator of the system, not by the hardware or software features of the system itself. While system 170 and system 180 are depicted and described below as separate systems operated by different individuals, it will be readily apparent that the use of separate systems and individuals is not a requirement and these functions could be combined in a single system and the services described below could be provided by a single individual, if so desired by the design services provider.

Representative tools 154 is a set of project management and product design tools intended to be used by account representatives and design representative to exchange information with customers and with each other during a product design project. Representative tools 154 include product design tools 152, as will be described in more detail below, that allow a design representative to create customized product designs using a plurality of component elements from memory 156 selected in accordance with the wishes and instructions of a customer and including additional design elements and/or text provided by the customer.

Memory 156 represents a portion of the memory capacity of DSS 120 that is devoted to storing the library of various component elements from which the design representative will select the individual component elements used to create the design of a custom product. While memory 156 is shown as a single block, it will be understood that the various components elements could be stored on multiple storage devices. In the embodiment shown, the component elements stored in memory 156 are categorized as layouts 156, images 158, color schemes 160, fonts 162, text groups 164, and patterns 166. It will be understood that more, fewer, or different categories of components could be employed, if desired. For example, the service provider could also provide clip art or shapes as component elements. Systems and methods using separately stored product component elements are disclosed in co-pending and commonly assigned application Ser. No. 10/449,386 entitled “Electronic Document Modification” filed May 30, 2003 and application Ser. No. 10/679,028 entitled “Electronic Product Design” filed Oct. 3, 2003, the disclosures of which are both hereby incorporated by reference in their entirety.

Prior to using the design services features of DSS 120, the customer must create a DSS 120 customer account. When a user of a UCS 100 creates a customer account, the information associated with that account is represented in FIG. 1 as conceptually contained in a customer area 122. While a single customer area 122 is shown for illustration, it will be understood that each customer account on DSS 120 with have its own similar customer area that contains information and materials related to the status of that particular account.

As will be described below, My Account 124, My Projects 132, My Portfolio 134 and My Proofs 136 are display screens available for downloading from DSS 120 and displaying to the customer on the UCS 100 display device. My Account 124 is the customer's main account page. In the example depicted in FIG. 1, My Account 124 contains three links to other display pages. If the customer selects link 126, My Projects 132 page is displayed. As will be discussed in more detail below, the My Projects 132 page contains information and additional links related to design services projects for that customer. In the example shown, the customer has one active design project area 138.

If the customer selects link 128 on My Account page 124, the My Portfolio page 134 is displayed. My Portfolio 134 provides summary information about, and links to, all product designs that have been saved in that customer account, including the designs of products purchased in the past and designs that have been saved, but have not yet been purchased. In the example of FIG. 1, My Portfolio 134 contains two product information fields, 144 and 146. Each product information field 144 and 146 displayed to the user contains a link to allow the user to request to view an image of the product and information about the product, such as the product identification number, the type of product, the date of creation, and whether the product has been purchased. A product information entry in My Portfolio 134 can be created either by the user having created a design using other design tools available to the customer on DSS 120, if other tools for use directly by the customer are provided by the service provider, or, as is the focus of this disclosure, by an account representative having transferred a design to My Portfolio from My Projects 132.

The customer using UCS 100 views images of the product design in relatively low resolution compatible with typical UCS 100 display systems, such as 72 dots per inch. Some customers desire to review a higher resolution print proof of a product design prior to placing an order for finished products. When a proof of a design is requested by a user and created by DSS 120, it is made available to the user on the My Proofs 136 page. If the user selects link 130, My Proofs 136 page is displayed. Similar to My Portfolio 134 discussed above, My Proofs 136 contains proof information areas 148 and 150. Each proof information area contains a link by which the user can request to obtain the proof image from DSS 120 and product information, such as the product identification number, the type of product, the date of creation, and whether the product has been purchased. The user can, if desired, download the proof and print it on a local printing system for review.

My Account 124, and the other displayed pages discussed above, would all also typically contain additional text, information, and links, not shown, such as links for the user to access an account update page, an order history page, a shopping cart, or a page showing personal images uploaded by that user as well as navigational links to other information on DSS 120, such as frequently asked questions, privacy policy, specific product pages, and so forth.

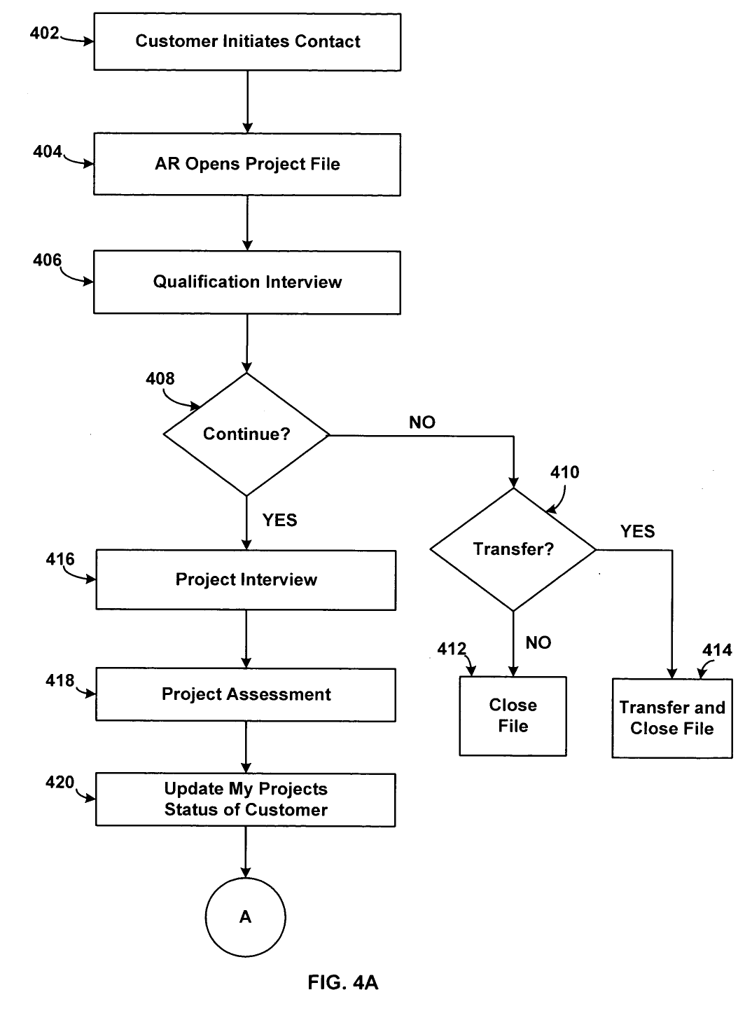

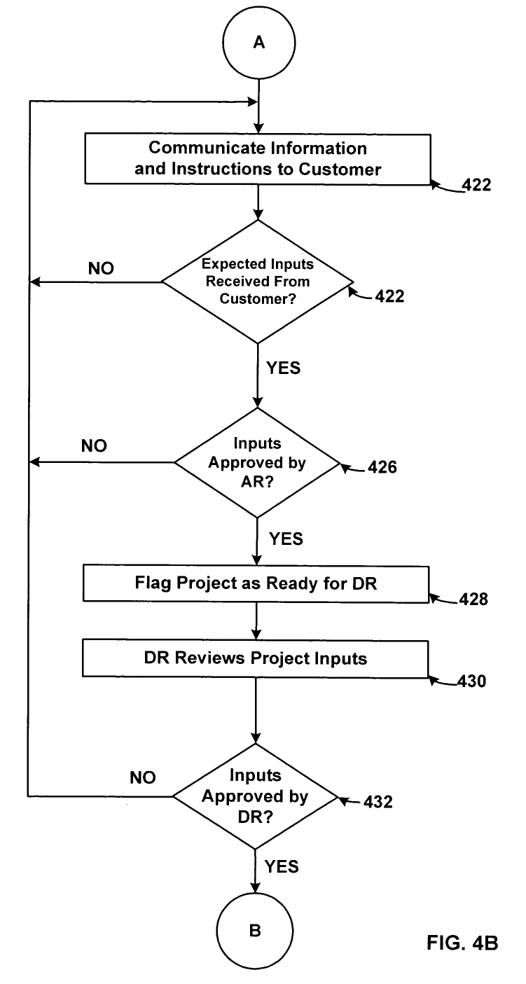

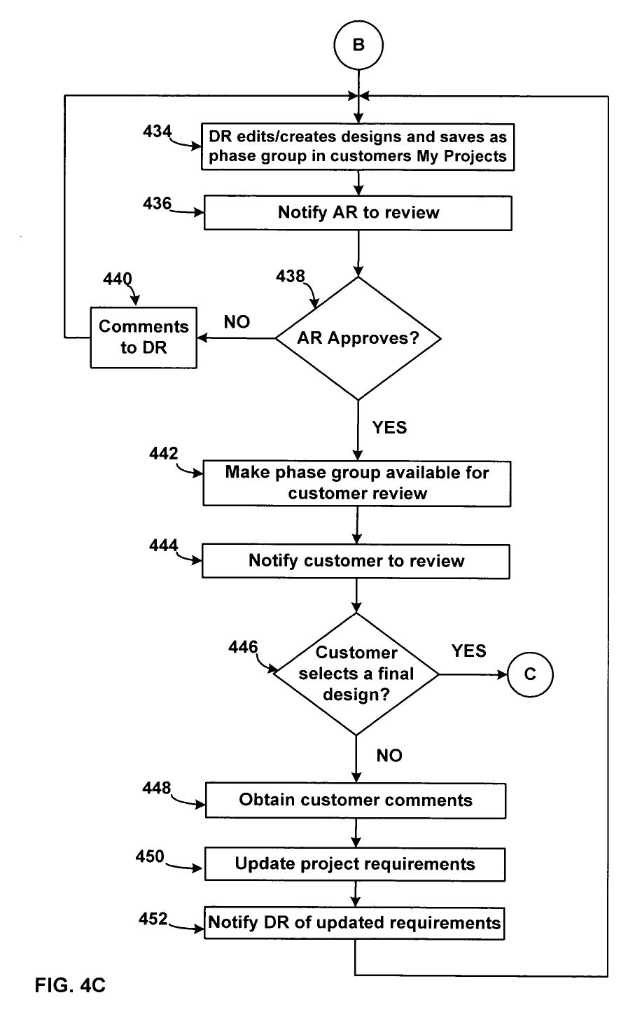

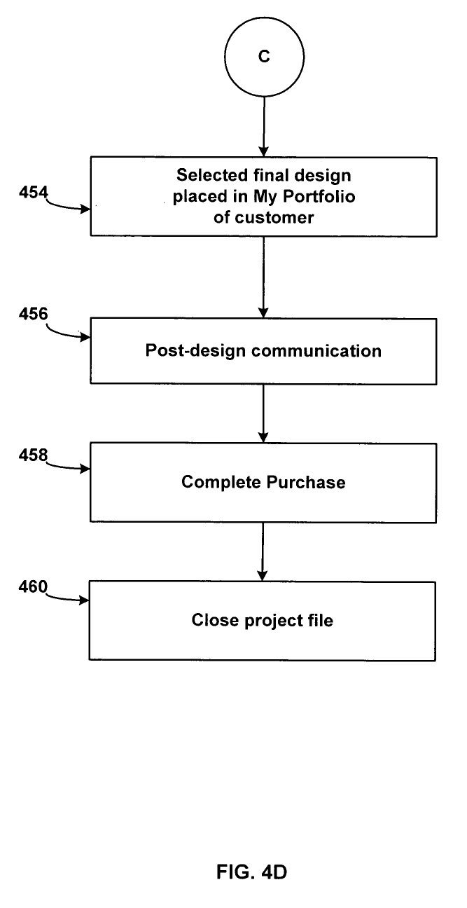

Referring now to FIGS. 4A-4D, an exemplary method for providing design services in accordance with the principles of the invention will be discussed. At step 402, a customer initiates contact with an account representative of the DSS 120 design services provider. The customer will typically make the initial contact by telephone, but email, web-based forms, or other means could be employed. As mentioned above, the design services provider employs account representatives who are familiar with the product and service offerings of the design service provider and are trained in interacting with customers to identify and satisfy the customer's design needs. Account representatives typically handle contacts with the customer. The use of account representatives provides several advantages over existing “self service” design tools by bridging the gap between the automated tools and potential customers who are reluctant for whatever reason to use the tools for designing a product.

The services provider also employs design representatives who are trained in using product design tools 152 to quickly develop a group of varied designs based on comments, text, and images provided by the customer. These service personnel are referred to herein as design representatives. The use of automated product design tools 152 yields several advantages for the service provider and for the customer. Design representatives using the automated tools do not need extensive graphic designer training or expertise to produce attractive and relevant product designs. In addition, the automated tools greatly reduce the amount of time required to produce each design. This results in high design representative productivity and, therefore, the ability for the service provider to offer design services at a lower price than competing graphic designers using manual methods.

At step 404, the account representative will open a preliminary design services system project file for internal reporting and work tracking purposes. At step 406, the account representative conducts a qualification interview with the prospective customer to determine what type of product or service the prospective customer is interested in. In some cases, the customer will be interested in a type of product or service that DSS 120 does not support. If this is the situation, the account representative will determine at step 408 that it is not appropriate to continue with the requested project. While the services offered by the service provider through DSS 120 may not be appropriate for this customer's request, the design services provider may have another division, subsidiary or affiliate that does have the requested capability. If transfer to another entity is not appropriate or is not approved by the customer, the project file is closed at step 412. If a decision to transfer the project to another entity is made at step 410, the project information is forwarded to the appropriate entity and the design services system project file is closed.

If continuation with the design services engagement is determined to be appropriate at step 408, the account representative proceeds to conduct a more detailed project interview at step 416. This will include the collection of information about the customer, including contact information such as the customer's name and email address. If the customer has not previously created a customer account with DSS 120, an account is established. The scope of the project interview will depend heavily on the specific goals, experience and status of the customer. Some customers may be first time visitors to the design services site while others may be returning customers. The type of products could range from simple documents, such as business cards, to much more complicated multisided/multipaged products. The scope of services required could also vary significantly. If DSS 120 is embodied as a feature or service of a printing service Web site that offers self-service type product design, some customers could have partially completed a product using other design tools available to the customer and only need assistance with performing a particular operation. Other customers may have done no preliminary work at all or are unsure of exactly what they want or how to get started.

When the relevant facts about the customer's goals for the project have been collected and the project interview is concluded, the account representative will assess the project at step 418 and open a new project area in My Projects 132 of the customer's area 122 at step 420. If the customer desires that multiple different products be designed, multiple individual project files are opened. As mentioned above, in the disclosed embodiment, the My Projects 132 area is the portion of the customer's area 122 on DSS 120 that is related to the customer's review and selection of a product design created by the design representative. The account representative will assign the project a name and enter a general product category, customer contact information, and relevant comments, explanations, and instructions for the design representatives use in preparing the candidate product designs.

Once the new project area has been opened in the customer's My Projects 132 area, a confirmation communication is sent to the customer including appropriate information and instructions to the customer regarding the project name assigned to the new project, how to access the customer's My Projects 132 area, and guidance regarding the further input required from the customer. In most circumstances, the customer will need to supply the specific text and images that the customer wants incorporated into the product design. The customer will be instructed to access a projects inputs page, discussed below, and to provide the necessary text entries, upload images and review the library of images available on DSS 120. When the customer has supplied the requested information, the account representative receives an indication that the inputs are available.

In some situations, the inputs may not be received from the customer on a timely basis. If the expected inputs have not arrived within a reasonable time period after step 422, the customer will be contacted again at step 424 either by the account representative or by an automatically generated email to remind the customer of the outstanding requirement for the customer's inputs.

When the account representative receives an indication that the inputs have been submitted, the account representative will review the inputs to determine if they are adequate and complete. If the account representative determines that the inputs are confusing, incomplete, or otherwise defective at step 426, the account representative will communicate a description of the deficiencies to the customer and request that the customer submit supplemental or corrected information. When the customer inputs are approved by the account representative, the account representative will flag the account at step 428 as ready for review by a design representative.

The assignment of design projects to individual design representatives could be implemented in various known ways. The new project could be placed in a pool of pending design projects available to all design representatives or could be assigned to a specific design representative in any other manner desired by the service provider, such as on a round robin basis or on the basis of an individual design representative's availability or expertise. At step 430, the design representative for the project reviews the inputs provided by the customer. If the design representative requires clarification or additional information, the design representative may send an appropriate communication to the customer. Alternatively, if the service provider desires that all customer communications be handled by the account representative, the design representative would pass the request to the account representative who, in turn, would communicate the description of the deficiencies to the customer for correction.

If the design representative approves the customer's inputs at step 432, the design representative will conduct the product design process at step 434. The design representative will typically prepare a number of different possible product designs based on the customer's inputs and save them collectively as a phase group in the customer's project area 138. Because a design project will typically require more than one iteration to reach completion, a project will typically involve the preparation and review of multiple phase groups.

When a phase group of product designs that are satisfactory to the design representative, has been prepared, the project is marked as “ready for account representative review” at step 436. If the account representative does not approve the phase group at step 438, the account representative will transmit comments regarding corrections or modifications to the design representative at step 440. The design representative will update the designs in the phase group as required to satisfy the account representative and again notify the account representative that the group is available for review. Up to this point, the phase group is accessible to the account representative and the design representative in a shared internal area associated with this customer and this project, but not visible to the customer in the customer's project area 138. When the account representative approves the phase group at step 438, the account representative changes the status of the phase to “ready for customer review”. This status change makes the phase group available to the customer in the associated project area 138.

At step 444, the customer is notified that a phase is available for the customer's review. The notification could be accomplished automatically, such as an email generated automatically in response to the change of status at step 442, or could be accomplished manually, such as by an email, telephone call or other communication, by the account representative.

When the customer reviews the designs in the phase group, the customer may be fully satisfied with a design and be ready to complete a purchase or the customer may desire modifications. If the customer does not approve a final design at step 446, additional comments will be obtained from the customer at step 448. Comments could be obtained in a telephone call, email message, or by using feedback links discussed below. If the customer desires to add or change images or text, the customer can update the inputs for the product using the project inputs page discussed below. Each submission of new or revised project inputs will generate a status indication that new or changed project information and/or requirements are available.

At step 450, the account representative will analyze the new information from the customer and update the project requirements, if necessary. At step 452, the account representative notifies the design representative that updated requirements, inputs or other information from the customer is available. The notification at step 452 initiates a new design and approval cycle as indicated by steps 434 to 452. For as long as the customer and the account representative desire to continue to pursue the design process, steps 434 to 452 will be repeated as necessary until the customer selects a final design at step 446.

After the notification from the account representative at step 452, the design representative will review the customer's new comments and new inputs, if any, and prepare another phase. Depending on the customer's comments and the particular circumstances of the project, the new phase could contain one or more modified versions of existing designs or one or more new designs, or both. As mentioned above, it is possible that a customer may wish to return to an earlier phase to review and reconsider one or more designs presented earlier. Therefore, each prior phase of the project is retained in project area 138 for review and reference by the customer.

It is, of course, possible that some customers will lose interest, cease to cooperate, decide to pursue a different solution, or for various other reasons fail to ultimately arrive at a final product design, but, in general, the process outlined above will continue until a suitable final design is selected at step 446. When a final design is selected by the customer, the selected final design is moved into the customer's My Portfolio 134. At step 456, as a part of wrapping up the project with the customer, the account representative has a final post-design communication with the customer to assist the customer in finalizing the transaction. This interchange might, depending on the product being designed, include advising the customer on delivery options, quantity options, printing options, and suggesting additional or related products that might be of interest to the customer. If the customer expresses an interest in one or more additional products requiring design services, the account representative can open one or more new project files for the new design projects. Initiation of new projects is not limited to beginning only at step 456. At any point in the process, the customer may request another design project. Multiple independent design projects for a customer can be underway in different stages of development at any given time. As mentioned, each project in progress would have its own project area, similar to project area 138, in the customer's My Projects 132. In the disclosed embodiment, each different product to be designed will be a separate project.

At step 458, the customer can, if appropriate, proceed to complete the purchase through the service provider's usual checkout and purchase process where the customer can provide shipping and billing addresses, specify desired quantity, select means of shipping, and arrange for payment. This process can be handled by the customer alone or with the continued assistance of the account manager. When the purchase process is completed, the design services project file is closed at step 460. The product design will typically remain available in the customer's My Portfolio for a period of time so that the customer can return and place additional orders, if desired. If the DSS 120 embodiment also makes design editing tools available for use by the customer, the customer can access the design in My Portfolio and update or edit the product design directly without involving the service provider's representatives. The project information area 138 and the various phase groups of preliminary designs associated with the completed project can be deleted from the customer's My Projects 132 area, unless the service provider desires to retain some or all of the information for future reference by the customer.

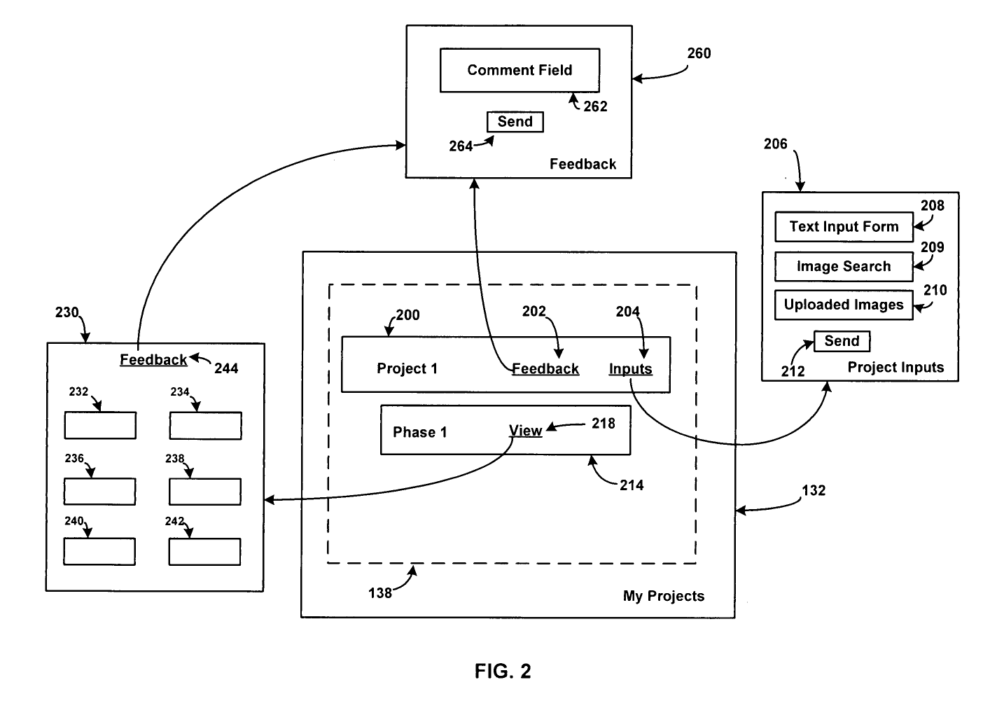

Referring now to FIG. 2, customer display screens accessible from My Projects 132 are depicted. As mentioned above, in this example, the user's My Projects 132 contains one active project, indicated by project area 138. Project area 138 includes general project information area 200. Project information area 200 would include the project title and other general information about the associated product design project, typically including the date of project initiation, a project identifier, and the name of the associated account representative and design representative assigned to this project.

Project area 200 also includes feedback link 202 and inputs link 204 to facilitate communication from the customer to the representatives. If the user selects feedback link 204, feedback page 260 is displayed. Page 260 contains an editable text area 262 in which the customer can enter comments or instructions regarding the project. When the customer's comments are ready for submission, the comments can be submitted to DSS 120 by the customer clicking on send button 264.

If the customer selects inputs link 204, project inputs page 206 will be displayed to the customer. In most situations, the customer will have specific text that the customer wants to incorporate into the product design. Many customers will also have one or more images, such as a logo or photograph, that the customer wishes to incorporate into the design. Project inputs 206 provides the user with specific tools to supply the necessary user inputs for use by the design representative when designing a product for the customer. Project inputs 206 could also include additional fields, such as a field for general comments about the inputs, if desired. Detailed instructions and guidelines for completing project inputs 206 will typically be provided to the user by the account representative via email shortly after completion of the qualification interview and assessment process.

Text input form 208 contains text fields relevant to the particular type of product being designed to provide the customer with a structured means of providing all information needed by the design representative to create a finished document. To the extent feasible, the text fields provided in form 208 correspond to the text fields in the text schemes used by product design tools 152.

Image search 209 allows the customer to use keywords to search the library of images available in image memory 160 for images that the customer would like incorporated into the product design. Keyword search 209, which could be implemented in various known ways, such as a drop down menu of keywords or a text field where the customer types in one or more search terms, allows the customer to search for images associated with a particular desired characteristic or content. Thumbnails of the images associated with the keyword are displayed to the user for review in a viewing area, not shown. The keyword search, image review, and selection process can be repeated by the customer as many times as the customer desires. The identifiers of all images selected by the customer will be retained as a part of project inputs 206 information and will be used by the design representative when preparing the customer's product designs. Keyword-based image searching in connection with electronic product design is disclosed in co-pending and commonly assigned application Ser. No. 10/646,554 entitled “Automated Image Resizing and Cropping” filed Aug. 22, 2003, the disclosure of which is hereby incorporated by reference in its entirety.

Uploaded images 210 provides a central location for the customer to upload any images, such as a photograph or a company logo, that the customer wishes to be incorporated into the product design. When the customer has entered any necessary text and uploaded any desired images, the information can be submitted to DSS 120 by the customer clicking on send button 212. The customer can return to this page during the course of the design project, if necessary, to add or modify text or to upload additional images. Each time the customer clicks send button 212 to submit project inputs 206, the available of new information from the customer is flagged to the representatives.

A design or a group of designs that are provided at one time for the user's review are referred to herein as a phase or phase group. Design projects may involve multiple cycles of design and review and, therefore, may involve the creation and review of multiple phases. In most circumstances, the first phase presented to the customer, identified in FIG. 2 as Phase 1, will contain a number of design variations based on notes taken by the account representative during a qualification interview and on the information provided in project inputs 206. In the disclosed embodiment, thumbnail images of several of the designs are grouped onto a single display page to facilitate the user's review and comparison. In the example situation represented in FIG. 2, project area 138 associated with project 1 contains one phase area 214. As additional phases are added during the progress of the project, each phase would have its own phase area and each phase area would typically contain relevant phase information, such as a description of the phase, a date the phase was created, and a name or other contact information for the associated account representative. Each phase area would also contain a link to allow the customer to view a display page displaying the thumbnail images associated with that phase. In this example, phase area 214 contains view link 218. If the user clicks on this link, associated phase 1 page 230 will be displayed to the user.

In this example, the design representative prepared six product design images 232-242 for the customer's review. More or fewer images could have been displayed. If required by the number or size of the images in the phase, phase display page 230 could comprise multiple pages or contain a scrollable viewing area. Display page 230 could be implemented in various ways according to the requirements of the user, the type of product being designed and the implementation of the design service provider. For example, each thumbnail image 232-242 could represent the same side of the product being prepared, for example they could depict six different designs for the front side of a poster, holiday card, brochure, postcard, business card, folder, or any one of a variety of other products. Alternatively, images 232/242 could be organized as sets of two or more related images depicting different sides or pages in a multisided or multipaged product. For example, the images could be pairs of related images depicting the designs for the front and back of a two-sided product. In the example discussed herein, thumbnail images 232-234 represent the front and backside designs for a two-sided product, such as a postcard or data sheet. Image pairs 236/238 and 240/242 represent two different front and back designs prepared by the design representative. Each thumbnail image, or set of related images, displayed on page 230 has an associated unique identifier, to allow the customer to unambiguously identify the product design when communicating with the account or design representatives. Each image or group of related images also has an associated link to allow the customer to request that a larger version of that thumbnail image be displayed to the customer to allow the customer to review the design in greater detail. Phase page 230 also contains feedback link 244 to allow the customer to access feedback page 260 from the phase group display page. To focus the customer's comments on the most recent phase page, only the customer's most recent phase page will have an active feedback link. Feedback link 244 will become inactive when a Phase 2 page becomes available for the customer's review. The new phase page will then have the active phase page feedback link.

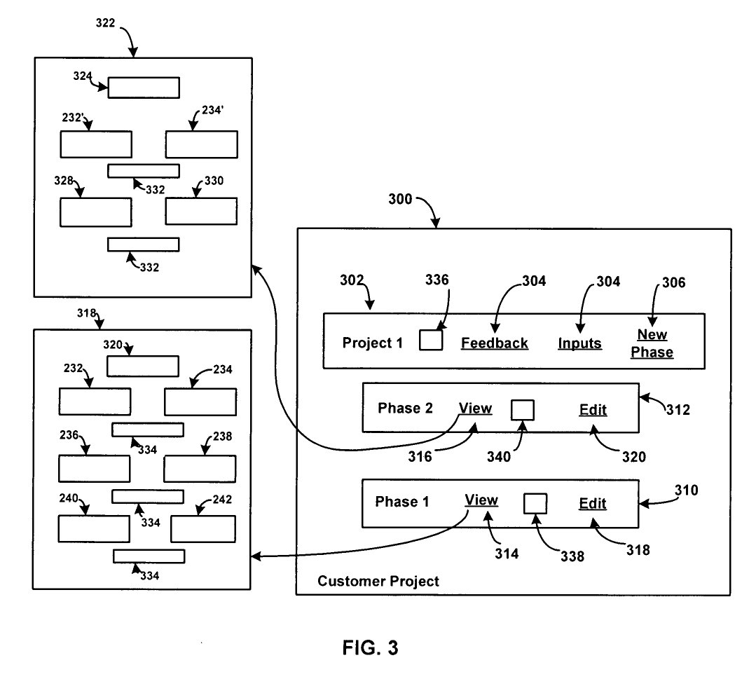

Representative tools 154 will allow the representatives to locate and display customer project information in various ways and formats. For example, a representative could request to view all pending projects, only the projects assigned to a specific representative, only the projects having a selected status, only projects for a specified customer, or in various other ways. Referring now to FIG. 3, customer project area 300 is representatives' displayed information corresponding to the customer's project area 138. Project display 300 has a project information area 302, a phase 1 information area 310 and a phase 2 information area 312. Area 312, as discussed in more detail below, relates to a phase that is in the process of being prepared and, therefore, has not yet been made available for customer review in the customer's project area 138.

Project information area 302 contains various relevant information about the project, such as a project identifier for internal tracking, a project name, an identifier of the type of product being designed, the name of the assigned account manager, and the name of the assigned design representative. Project information area 302 also contains links to project related information. Feedback link 304 allows the representative to review the accumulated comments and messages provided by the customer using feedback display 260. Inputs link 306 allows the representative to review the project inputs 206 information supplied by the customer. New phase link 308 initiates the creation of another phase.

Each phase information area 310 and 312 contains information about that particular phase of the project, such as a phase title or description, a creation date, and a current phase status. In the disclosed embodiment, each phase can be in one of three possible states: under development, ready for account representative review, and ready for customer review. Until the design representative has completed the process of creating and saving the desired number of product designs in a phase, the phase is in the “under development” state. When the design representative has completed the group of product designs, the design representative changes the state of that phase to “ready for account representative review”. Finally, when the account representative has reviewed the phase for compliance with the customer's request and approved the phase for release to the customer, the account representative changes the state of the phase to “ready for customer review”. This causes the phase to become accessible to the customer in the customer's project area 138. To alert the customer to the availability for review of the new phase, a notification email message can be automatically generated and transmitted to the customer's email address or, if a more personal approach is desired, the account representative can use a personal approach and contact the customer by telephone or by a personalized email message.

Each phase information area also provides a link, view 314 and view 316, to allow the representative to view the display page associated with each phase. Selection of link 314 displays phase display 318 containing the thumbnail design images 232-242 presented to the customer as phase 1. In the example depicted in FIG. 3, the design representative has received feedback from the user and/or the account representative and has prepared a second group of designs identified as phase 2. Subsequent phases could contain one or more revised or new designs. A subsequent phase could also contain one or more unrevised designs copied from an earlier phase that the user is still considering. The information about this phase is displayed to the representative in phase area 312, similarly to as was discussed in connection with phase area 310. Selection by the user of view link 316 causes phase display page 324 to be displayed to the user. In this example, the user has indicated that the user is not interested in image pairs 236/238 or 240/242, would like modifications to image pair 232 and 234, and would like to see a new design. In response to the customer's comments, the design representative has prepared phase 2 comprising modified versions of image pair 232 and 234, identified as 232′ and 234′ and a new image pair design 328/330.

Displays 318 and 322 also provide a number of phases controls 320 and 324 allowing the representatives to take actions regarding that phase group. The specific set of controls available depends on whether the phase display page is the current phase page or an earlier phase version. For example, controls 326 displayed on current phase display 324 would contain links allowing the representative to edit the status and other information related to the phase, to initiate creation of another document for the phase, and to view the messages and feedback supplied by the customer. Controls 320 displayed on prior phase display 318, which has already been made available to the customer, would not have active links for editing the phase status or date or for creating a new document.

In addition to controls for the phase as a whole, each image or group of related image has an associated set of controls, identified as controls 322 and controls 332, allowing the representative to take specific actions for selected images. Again, the number of active controls available to the representative depends on whether the phase displayed is the current phase or a prior phase already available to the customer. Controls 322 would include a link to have a copy of a selected image placed in the current phase for further editing or revision as requested by the customer. Controls 322 would also include a link to have a copy of a selected image placed into the customer's portfolio. Controls 326, being associated with the current phase being prepared for customer review, would have additional active tools, such as links to assign a new name to a design, to delete a design from the group, and to initiate the image editing process.

During the course of a design project, various actions cannot be performed until another action has first been taken by another party. Information about the current status of a customer's project is available internally to the account representative and the design representative through status labels and alerts available in project status area 336 and phase status areas 338 and 340. Some alerts in project status alert area 336 are triggered by the customer's failure to submit the required project inputs, failure to respond to a request for additional information, or failure to send feedback after being informed that a phase is available for review in a timely manner. The amount of time allocated for he customer to perform an action could be predetermined for each action or could be set by the account representative based on individual customer circumstances. Alerts in alert area 336 are also triggered by affirmative actions by the customer, such as receipt of feedback form 260, receipt of project inputs form 206, and receipt of notice that the customer has selected a final design. The foregoing alerts are all monitored by the account representative. The account representative also monitors for status alerts from the design representative, such as a rejection or other feedback regarding the customer's project inputs, and for an indication that the phase has been completed and is ready for account representative review. The design representative will monitor for relevant alerts from the account representative in project alert area 332, such as availability of new or updated project inputs, and in the current phase alert area 334, such as a rejection or other feedback regarding the phase.

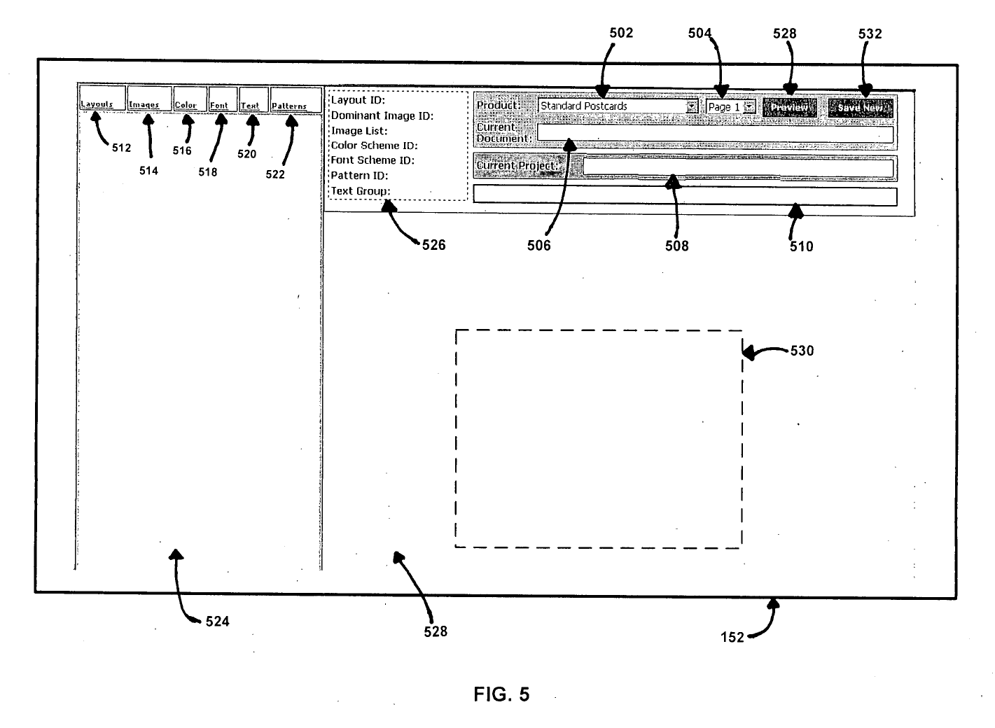

Referring now to FIG. 5, an embodiment of product design tool 152, also referred to herein as picker 152, will be discussed. Picker 152 provides a flexible set of tools that enables the design representative to quickly and efficiently prepare a variety of product designs for a range of different products.

The embodiment depicted in FIG. 5 provides a centralized location for tracking and controlling the functions of the product design creation process. Drop down menu 502 allows the design representative to establish the type of product being designed in this project. As mentioned above, in this example the service provider requires each project to be limited to a single product, therefore menu 502 will not be used further after the initial product selection. In other situations, the service provider may choose to allow design representative to create designs for multiple different products in a single project. Drop down menu 504 displays the current page or side of the product currently being designed and allows the design representative to select and design a different page of the product. Field 506 displays the name or other identifier for the current product design. Field 508 displays the name or other identifier for the current customer project for which the product design is being created. Field 510 is a general informational field used for displaying system status, progress or other informational messages to the design representative.

As mentioned above, each product design is created by combining a number of component elements, typically including a layout, one or more images, a color scheme, a font scheme, text scheme and, if appropriate, a pattern. The individual components to be used in a design are selected by the design representative using links 512, 514, 516, 518, 520 and 522. When one of the links is selected, appropriate thumbnail images for that component category are retrieved from memory 156 and displayed to the design representative in display area 524. For example, if the design representative selects link 512, thumbnail images of various layout designs for the type of product selected in menu 502 are retrieved from layout memory 158 and displayed for review by the design representative in display area 524. Each layout, and all other individual component elements stored in memory 156, has an associated number or other unique identifier. When the design representative selects one of the available layouts, the identifier of the selected layout is displayed in component summary area 526 as the “layout ID”.

While images are not a requirement in a layout and some layouts may not use any images, most layouts have one or more image containers into which the design representative can place images. When the design representative clicks on images link 514, the design representative is presented with additional links that allow the design representative to view the images, if any, that were provided by the customer using uploaded images 210 or selected by the customer using image search 209 on the project inputs 206 page. If no images were uploaded or selected by the customer, or if the design representative needs to select additional images to supplement the supplied images, the design representative can retrieve thumbnails of available images are retrieved from image memory 160 and displayed in display area 524 for review by the design representative. When the design representative selects one of the images in display area 524, the identifier associated with that image will be displayed in summary area 526 as the dominant image ID. Because some layouts will have more than one image container, the design representative can select multiple images. The identifiers of all images selected will be displayed as the image list. To facilitate the rapid identification of images with a desired content or theme, images link 514 could advantageously incorporate the capability to search for images by keyword.

To provide a range of design effects, the layouts incorporate image areas having varying ratios of image height to width. It would be very labor intensive and require substantial data storage capacity for the service provider to attempt to pre-generate and store a different cropped version of every image sized to fit every possible image container in every possible layout. In the embodiment discussed herein, the images displayed in image area 524 represent the entire uncropped image that is available. To facilitate the rapid and efficient preparation of a suitably cropped version of the image having the proper shape to fit the intended image area provided in the layout, selection of an image causes a cropping window to be opened displaying the selected image and a crop box allowing the design representative to select the desired portion of the image to be incorporated into the design. Various tools for image cropping are known in the art. Cropping tools that facilitate image cropping by automatically displaying the selected image with a crop box pre-positioned in a suggested cropping location are disclosed in co-owned and co-pending application Ser. No. 10/713,446 entitled “Image Cropping System and Method” filed Nov. 14, 2003, the disclosure of which is hereby incorporated in its entirety by reference.

In some layouts, images are displayed on a colored background or with a colored border. To assist the design representative in developing a design that places an image with a background or border that is complementary, the service provider may have chosen to associate a particular color scheme with some or all of the images by storing an indication of the identifier of a color scheme that is considered attractive when used with that image. The selected color scheme will also affect the appearance of other elements in the design, such as the colors in which fonts and some patterns will appear. If the design representative selects an image having an associated color scheme, the unique identifier of that color scheme will be displayed in summary area 526. This saves the design representative the effort of independently selecting a color scheme. If the selected image does not have an associated color scheme or if the design representative desires to use a different color scheme, the design representative can select color scheme link 516 and review a menu of available color schemes in display area 524.

When the design representative selects font link 518, a list of available predetermined font schemes is displayed in display area 524. Each scheme would display a set of two or more fonts that will be used for the text elements of the product design.

To assist the design representative to prepare designs quickly, the service provider has predefined and stored text boxes and associated text entries and descriptive titles for a wide range of potential customer needs in text memory 166. When the design representative selects text group link 520, a list of titles of text groups for the type of product being designed is displayed in area 524. Each title is a link to a more detailed display of the components of that text group. For example, if the product being designed is a postcard, which are often used for promotional purposes, when the design representative initially selects text group link 520, a list of descriptive titles for potentially relevant text groups will be displayed for business activities such as accounting, child care, construction, real estate, and the like. Multiple different text groups could be provided within each of these general categories. For example, if the design representative were to select a title link called “Art & Photography—Sale”, a set of individual text boxes with relevant text pre-filled would be displayed in display area 524. To assist the design representative, each text box is displayed with an associated title, such as “heading”, “subheading”, or “address line 1”. Some or all fields could be blank or some or all could be pre-filled with placeholder information or guidance, such as “insert company name here”, or suggested text, such as “Custom Framing is our Specialty”. As mentioned above, to the extent feasible, the text entry fields provided for the customer to complete in text input form 208 will correspond to similar text areas in the pre-defined text groups established for that type of product. When the design representative selects a text group, the text entries provided by the customer will be automatically displayed in the corresponding text boxes of the text group. Each text box displayed in area 524 is editable, allowing the design representative to edit the text information provided by the customer, as needed.

In the disclosed embodiment, to enlarge the range of design possibilities, some layouts are designed to include an area that is intended to be filled with a pattern. A pattern could be, for example, an image replicated many times to produce a tile effect or could be a gray scale image. If the design representative is using a template that accepts a pattern, the design representative can select pattern link 522 and review thumbnails of pattern images in display area 524.

When the design representative has selected the components to be combined into a product design, the design representative selects preview button 528 to cause an image of the combination, represented by dashed lines 530, to be generated and displayed to the design representative in display area 528. If the design representative is satisfied with the design, the design representative can select save now button 532. This will cause the design to be saved as a part of the current phase group being prepared by the design representative. If the design representative is not satisfied with a design, the design representative can again use links 512-522 to individually replace one or more of the component elements. Each time the design representative selects preview 528, an updated image of the combination of components is generated and displayed as image 530. When satisfied, the design representative can save the design using save now 532 for future review by the customer. After having saved a product design, the design representative can create another design simply by using links 512-522 as desired to replace one or more component elements. Other features can be provided to assist the design representative in the rapid designing of additional sides or pages of multipage/multisided products. For these types of products, the customer often desires that at least some component elements, such as color schemes and font schemes, be used consistently throughout the product. When the design representative has designed and saved a first page or side of a product, designing of subsequent pages/sides is simplified by pre-filling the summary area 526 for the following page or pages with the relevant component elements used in designing the first side or page. The design representative can modify these initial selections, if desired. The service provider may also have developed sets of layouts specifically designed to be complementary and to be used for different sides or pages of the same product. In this situation, if the layout selected for one page or side of a product has one or more complementary layouts associated with it, one or more of these complementary layouts will be suggested to the design representative for use on the other page or side. The use of associated layouts having common component elements is disclosed in the above-referenced application Ser. No. 10/679,028.

Picker 152 gives the design representative the flexibility to very quickly accommodate a large variety of customer requests that might be encountered. Elements that are liked by the customer can be retained while only the other component elements are changed. For example, a customer might like an image, but want to see it presented in different layouts, or might like a layout, but want to see different image or color schemes, or might want to see a design with everything the same except for the text being presented in a variety of different fonts, or any number of other possibilities.

It will be understood that the details of the implementation of the various windows, links, and tools described above in connection with picker 152 could have been implemented in other known ways and that more, fewer, or different tools could have been employed.

While an illustrative embodiment has been discussed, alternate embodiments could also be employed. Therefore, the described embodiment is to be considered as illustrative rather than restrictive and the scope of the invention is as indicated in the following claims and all equivalent methods and systems.

What is claimed is:

1) A system for exchanging design project information over a communication network between a customer computer system and a server system, the system comprising one or more web pages available to the customer computer system from the server over the network, the one or more web pages providing at least a customer input tool allowing the customer to enter and transmit information over the network for incorporation at the server into one or more designs, one or more information fields containing information about the design project and about any designs available for review by the customer, at least one review request tool allowing the customer to request the server to transmit images of one or more designs that are available for review to the customer computer system, and a feedback tool allowing the customer to enter comments about the design project and transmit the comments over the network to the server.

2) A system for allowing an operator to create a custom design for a customer, the system comprising
a plurality of electronically stored design components, each component associated with a design element category,
one or more tools allowing the operator to select a design element category and causing information about at least some of the component elements in the selected category to be displayed to the operator,
one or more tools allowing the operator to select a component element in a plurality of categories for combination with other selected component elements and at least some information provided by the customer into a design,
a preview tool causing an image of the combination of the selected component elements and at least some information supplied by the customer to be generated and displayed to the operator, and
a save tool causing the displayed image of the combination to be saved for review by the customer.

3) A system for customer submission of information for use in an electronic design project from a customer computer system to a server system over a network, the system comprising
a text entry form allowing the customer to enter text information for incorporation into the design,
an image uploading tool allowing the customer to transmit one or more customer images from the customer computer to the server for incorporation into the design, and
an image selection tool allowing the customer to review images available at the server and identify one or more images at the server for incorporation into the design.

4) A method for creating electronic designs for a customer having a remote computer system capable of being connected to a server system via a communication network, the method comprising
associating an account on the server with the customer such that the customer can access the product designs on the server via the network,
receiving information at the server from the remote computer system for incorporation at the server into the product design;
creating one or more designs by electronically combining at least some of the received information with a plurality of design components selected from a library of electronically stored design components,
retaining images of the one or more designs at the server in an area associated with the customer's account, allowing the customer to access the retained images over the network;
receiving comments from the customer requesting changes to the one or more designs;
creating one or more different designs in accordance with the received comments, and
retaining images of the one or more different designs at the server in the area associated with the customer's account.

5) The method of claim 4 wherein the information is one or more of the group comprising text supplied by the customer, images supplied by the customer, and images at the server identified by the customer.

6) A method for creating electronic designs for a customer having a remote computer system capable of being connected to a server system via a communication network, the method comprising
a) entering into a design engagement with the customer,
b) receiving from the remote computer system information for incorporation at the server into a design;
c) creating and saving one or more custom designs at the server by, one or more times,
i) selecting a category of component elements from a plurality of component element categories,
ii) in response to the selection, displaying at least some component element options in the selected category,
iii) selecting a component element in the selected category,
iv) repeating steps b(i)-(iii) until the desired component elements have been selected,
vi) combining the selected component elements with at least some information received in step a) to create a design, and
vii) saving an image of the customized design,
d) providing the customer the ability to access the one or more images over the network, and
e) notifying the customer that the one or more images are available for access.

7) The method of claim 6 wherein the information is one or more of the group comprising text supplied by the customer, images supplied by the customer, and images at the server identified by the customer.

8) The method of claim 6 wherein step c(vi) further comprises the steps of viewing the product design created at step c(vi) and, if the design is not satisfactory, repeating steps c(i)-(vi) until the product design is satisfactory.

9) The method of claim 6 wherein step d) further comprises reviewing the saved designs prior to providing the customer the ability to access the saved designs.

10) The method of claim 9 wherein step c(i)-(vii) are performed by a first individual and step d) is performed by a second individual.

11) The method of claim 6 further comprising
f) receiving comments from the customer regarding the saved images and
g) repeating steps c(i)-(vii) one or more times to create and save one or more different images.
